(19) United States
(12) Patent Application Publication
(10) Pub. No.: US 2024/0327588 A1
(43) Pub. Date: Oct. 3, 2024

(54) SILICONE FOAM COMPOSITION

(71) Applicants: DOW GLOBAL TECHNOLOGIES LLC, Midland, MI (US); DOW SILICONES CORPORATION, Midland, MI (US)

(72) Inventors: Shuqi LAI, Midland, MI (US); Jody J. HENNING, Midland, MI (US); Yanhu WEI, Midland, MI (US); Kshitish A. PATANKAR, Midland, MI (US); Mark F. SONNENSCHEIN, Midland, MI (US)

(21) Appl. No.: 18/580,563

(22) PCT Filed: Jul. 18, 2022
(86) PCT No.: PCT/US2022/037412

§ 371 Date: Jan. 18, 2024

Related U.S. Application Data
(60) Provisional application No. 63/223,569, filed on Jul. 20, 2021.

(51) Int. Cl. C08J 9/00; C08J 9/02; C08L 83/04

(52) U.S. Cl. CPC C08J 9/0047; C08J 9/02; C08L 83/04; C08J 2383/05; C08J 2483/06; C08L 2205/02

(57) ABSTRACT

This disclosure relates to silicone foam compositions for forming foamed silicone elastomers, the respective foamed silicone elastomers formed therefrom and to methods of making such compositions and foamed silicone elastomers. The silicone rubber foam composition comprises the (a) one or more organosilicon compounds having an average of at least two silicon bonded alkoxy groups per molecule selected from one or more silicone resins and/or silicone resin intermediates; (b) a Lewis acid catalyst; (c) one or more surfactants; and (d) one or more organopolysiloxane polymers having an average of at least two, alternatively at least three silicon bonded hydrogen groups per molecule.

This disclosure relates to silicone foam compositions for forming foamed silicone elastomers, the respective foamed silicone elastomers formed therefrom and to methods of making such compositions and foamed silicone elastomers.

Foamed silicone elastomers are used in a wide range of applications such as for joint sealants, insulators and mechanical shock absorbers because of a variety of beneficial physical properties, not least thermal stability, low flammability and electrical resistance.

Room temperature vulcanization (RTV) silicone foams are almost exclusively provided as two-part compositions, which after mixing, are designed to cure with simultaneous gas generation which causes the resulting mixture to foam during the cure process. Usually, the gas produced is hydrogen, being a product of a catalysed dehydrocondensation reaction between compounds having silicon bonded hydrogen (Si—H) groups and hydroxyl-functional components. Originally, the reaction which took place was between a silicone polymer having an average of two or more —OH groups and a silicone polymer having an average of two or more silicon bonded hydrogen (Si—H) groups catalysed with a tin catalyst. This resulted in the formation of Si—O—Si bonds and the release of hydrogen gas (i.e., a chemical foaming agent) which caused foaming. However, this process became unpopular because some of the preferred catalysts were believed to have undesirable toxic effects.

Increasingly therefore, the majority of current RTV silicone foam compositions are now prepared utilizing expensive platinum group metal-based catalysts, mainly platinum-based catalysts, that catalyze both the hydrosilylation cure process of the composition and/or a dehydrocondensation reaction process between compounds containing Si—H groups and compounds containing —OH groups, again generating hydrogen gas which is consequently used as the means of foaming the composition.

Whilst this platinum group cured process works well, disadvantages remain. The platinum group catalysts are expensive and materials cured by such catalysts can suffer from discoloration and the formation of colloidal platinum particles over time. Such catalysts can have additional problems as they can be poisoned in the presence of impurities, such as nitrogen and sulfur-containing heterocyclics.

Furthermore, the continued reliance on flammable hydrogen gas in the foaming process, raises potential safety concerns for users because, for example, the presence of hydrogen gas at concentrations between the lower and upper explosion limits (LEL and UEL) in an environment where sparks and/or high heat exist is potentially hazardous.

Efforts have been made to identify alternative routes to generate silicone foams. For example, John. B Grande et al. in Polymer 53 (2012) p. 3135-3142, reported the generation of silicone foams by means of a Pierse-Rubinsztajn reaction by reacting an Si—H terminated polydimethylsiloxane with an alkoxysilane crosslinker such as tetraethyl orthosilicate catalysed using an organo-borane catalyst, tris(pentafluorophenyl)borane (B(C₆F₅)₃). Alkane gases were generated and utilised as the blowing agents instead of hydrogen. More recently, WO2020/028299 describes a process substantially relying on the use of physical blowing agents as an alternative to chemical blowing agents which generate hydrogen. However, WO2020/028299 still relies on expensive and potentially problematic platinum catalysts for curing the composition.

In view of the foregoing, there remains an opportunity to provide improved compositions for forming foamed silicone elastomers. There also remains an opportunity to provide improved foamed silicone elastomers, and improved methods of forming such compositions and foams.

There is provided a silicone rubber foam composition comprising:
(a) one or more organosilicon compounds having an average of at least two silicon bonded alkoxy groups per molecule selected from one or more silicone resins and/or silicone resin intermediates;
(b) a Lewis acid catalyst;
(c) one or more surfactants; and
(d) one or more organopolysiloxane polymers having an average of at least two, alternatively at least three silicon bonded hydrogen groups per molecule.

There is also provided a silicone rubber foam which is a foamed and cured product of the above composition.

There is also provided a method of making a silicone rubber foam composition comprising:—
Mixing a silicone rubber foam composition comprising
(a) one or more organosilicon compounds having an average of at least two silicon bonded alkoxy groups per molecule selected from one or more silicone resins and/or silicone resin intermediates;
(b) Lewis acid catalyst;
(c) one or more surfactants; and
(d) one or more organopolysiloxane polymers having an average of at least two, alternatively at least three silicon bonded hydrogen groups per molecule;
and causing foaming whilst the composition cures.

It was found that the addition of a surfactant in the composition described above resulted in foams prepared using such compositions having much better cellular structure. The fact that alkanes are generated as chemical blowing agents means the generation of foam is safer than when using the previously preferred hydrogen gas as foaming agent because of the narrower explosive limits of alkanes. Furthermore, as discussed above, the present composition does not rely on the use of expensive platinum-based catalysts and hydrosilylation cure processes which reduces costs involved but also avoids discoloration and formation of colloidal platinum particles over time. Furthermore, the catalysts used do not appear to be poisoned in the presence of impurities, such as nitrogen and sulfur-containing heterocyclics unlike platinum catalysts.

Component (a): One or More Organosilicon Compounds Having an Average of at Least Two Silicon Bonded Alkoxy Groups Per Molecule Selected from One or More Silicone Resins and/or Silicone Resin Intermediates

When the one or more organosilicon compounds having an average of at least two silicon bonded alkoxy groups per molecule (a) is a silicone resin, the silicone resin may comprise any suitable combination of M, D, T and/or Q siloxy units provided it includes a plurality of T and/or Q units to ensure a three-dimensional network molecular structure together with an average of at least two silicon bonded alkoxy groups per molecule. Organopolysiloxanes contain multiple siloxane linkages and can be characterized by the siloxy (SiO) groups that make up the polysiloxane. Siloxy groups are M-type, D-type, T-type or Q-type. M-type siloxy groups can be written as ≡SiO_{1/2} where there are three groups bound to the silicon atom in addition to an oxygen atom that is shared with another atom linked to the siloxy group. D-type siloxy groups can be written as ═SiO_{2/2} where there are two groups bound to the silicon atom in addition to two oxygen atoms that are shared with other atoms linked to the siloxy group. T-type siloxy groups can be written as —SiO_{3/2} where one group is bound to the silicon atom in addition to three oxygen atoms that are shared with other atoms linked to the siloxy group. Q-type siloxy groups can be written as SiO_{4/2} where the silicon atom is bound to four oxygen atoms that are shared with other atoms linked to the siloxy group.

For the avoidance of doubt, the silicone resins of component (a) also include those resins often referred to as “silicone resin intermediates” or “silicone oligomers” (henceforth referred to as silicone resin intermediates). These are silicone resins of relatively low molecular weights whose molecules have an oligomeric three-dimensional network structure. They may be used as resins on their own but may also be used as organic resin modifiers.

Preferably the silicone resin is a liquid at room temperature. In specific embodiments, the silicone resin may be exemplified by an organopolysiloxane that comprises only T units, an organopolysiloxane that comprises T units in combination with other siloxy units (e.g., M, D, and/or Q siloxy units), or an organopolysiloxane comprising Q units in combination with other siloxy units (i.e., M, D, and/or T siloxy units) providing the resin has an average of at least two silicon bonded alkoxy groups per molecule.

For example, providing the resin has an average of at least two silicon bonded alkoxy groups per molecule, the resin may be substantially formed from multiple groups of formula:

R⁵_{f″}SiO_{(4-f″)/2}

wherein each R⁵ may be the same or different and is a substituted or unsubstituted monovalent hydrocarbon group of 1 to 20 carbon atoms, for example, alkyl groups such as methyl, ethyl, propyl, hexyl, octyl, dodecyl, tetradecyl, hexadecyl, and octadecyl, or an aromatic group having 6 to 20 carbons such as benzyl, naphthyl and phenylethyl groups or alkenyl groups such as vinyl, propenyl, n-butenyl, t-butenyl, pentenyl, hexenyl, octenyl and the like and wherein each f″ is from 0 to 3. If the resin is a T resin, then most groups have f″ as 1 and if the resin is an MQ resin to largely comprises groups where f″ is 0 (Q groups) or 3 (M groups) as previously discussed.

The average formula for the above organopolysiloxane may be alternatively written as (ZO_{1/2})_{w}(R⁵₃SiO_{1/2})ₛ(R⁵₂SiO_{2/2})ₓ(R⁵SiO_{3/2})_{y}(SiO_{4/2})_{z},

where R⁵ is as defined above, Z is H or an alkyl group of 1 to 20 carbon atoms, for example, methyl, ethyl, propyl, hexyl, octyl, dodecyl, tetradecyl, hexadecyl, and octadecyl, alternatively each Z is an alkyl group having from 1 to 6 carbons. Subscripts s, x, y, and z are mole fractions such that s+x+y+z=1. Hence, subscript w is a value in a range from 0.1 to 1.5, alternatively 0.1 to 1.1, because more than one ZO_{1/2} can be attached to either T or Q units and subscripts s, x, y, and z are independently from greater than or equal to (≥) 0 to less than or equal to (≤)1, with the proviso that s+x+y+z=1. Subscript x is a value selected from a range of 0-0.5,alternatively from 0 to 0.1; y is a value selected from a range of from 0-1, subscript s is a value selected from a range of 0 to 0.6 and subscript z is a value selected from a range of 0 to 0.6. For the avoidance of doubt, ZO_{1/2} units may be attached to one or more of the R⁵²SiO_{2/2}(D), R⁵SiO_{3/2}(T) and/or SiO_{4/2}(Q) groups in each case via the oxygen linkage, and there must be an average of two such linkages per molecule. Typically, a maximum of only one ZO_{1/2} unit is bonded with a (R⁵₂SiO_{2/2}) group. Preferably most if not all alkoxy groups are sterically unhindered so that they can participate in the cure/foaming process.

The values for subscripts s, w, x, y, and z may be determined using ²⁹Si, ¹³C and ¹H nuclear magnetic resonance spectroscopy (see, e.g., The Analytical Chemistry of Silicones, Smith, A. Lee, ed., John Wiley & Sons: New York, 1991, p. 347ff.).

As indicated above, the silicone resins of component (a) may comprise any suitable combination of (ZO_{1/2}), (R⁵³SiO_{1/2}), (R⁵₂SiO_{2/2}), (R⁵SiO_{3/2}) and (SiO_{4/2}) groups for example a T type resin (the above where subscript z is zero and subscript y is >0) or Q type resin (the above where subscript y is zero and subscript z is >0). Together in each instance the resin is most likely to comprise either or both Q and T units with M (R⁵₃SiO_{1/2}) and/or D units, where each R⁵ is as described above but is preferably a phenyl group or an alkyl group having from 1 to 6 carbons, e.g., a T type resin where each R⁵ selected from methyl, ethyl and phenyl groups but the silicone resin additionally contains multiple alkoxy groups. For example, a T resin may comprise a selection of the following units:
(PhSiO_{3/2}), (alkylSiO_{3/2}), (alkyl Ph SiO_{2/2}), (alkyl₂SiO_{2/2}), (Ph₂ SiO_{2/2}) with at least two (ZO_{1/2}) groups per molecule.

Typically, each alkyl group above and each Z present is a methyl or ethyl group, alternatively a methyl group. In one embodiment up to 20 wt. % of the silicone resin in component (a) may comprise alkoxy groups, alternatively from 5 to 20 wt. % of the silicone resin in component (a) may comprise alkoxy groups, typically methoxy groups.

Whilst typically, silicone resins will have a weight-average molecular weight of at least 3,000, component (a) herein may include as the aforementioned silicone resin intermediates which are silicone resins of relatively low molecular weight, whose molecules have an oligomeric three-dimensional network structure. These silicone resin intermediates may be used as resins on their own but may also be used as organic resin modifiers. Typically, they have a weight average molecular weight of from about 200 to 3000 Da, alternatively from about 300 to 3000 Da. Hence the silicone resins of component (a) may be one or more silicone resin intermediates having an average of at least two silicon bonded alkoxy groups per molecule with a weight-average molecular weight of from 200 to 3000 Da, alternatively 300 to 3000 Da, alternatively 300 to 2500 Da, alternatively 300 to 2000 Da.

Alternatively, the silicone resins of component (a) may have a weight-average molecular weight of at least 3,000, component (a) herein 3,000, or more, 4,000 or more, 6,000 or more, 8,000 or more, 10,000 or more, 12,000 or more, 14,000 or more, 16,000 or more, 18,000 or more, 20,000 or more and at the same time desirably has a weight-average molecular weight of 50,000 or less, 48,000 or less, 46,000 or less, 44,000 or less, 42,000 or less, 40,000 or less, 38,000 or less, 36,000 or less, 34,000 or less, 32,000 or less 30,000 or less, 28,000 or less, 26,000 or less, 25,000 or less, or even 24,000 or less and any combination of the above maxima and minima values. Hence, component (a) as herein defined may have a weight average molecular weight of from 300 to 50,000 Da. Weight-average molecular weight identified herein may be determined in Daltons using triple-detector gel permeation chromatography (light-scattering, refractive index and viscosity detectors) and a single polystyrene standard.

Suitable silicone resins are obtainable by synthetic methods taught in U.S. Pat. Nos. 2,676,182, 3,627,851, 3,772,247, 8,017,712 and 5,548,053, the contents of which are incorporated herein by reference.

Typically, the concentration of the one or more one or more organosilicon compounds having an average of at least two silicon bonded alkoxy groups per molecule selected from one or more silicone resins and/or silicone resin intermediates (a) is from 2 to 50 weight-percent (wt. %) of the composition, alternatively from 2 to 45 wt. % of the composition, alternatively from 3 to 40 wt. % of the composition.

### Component (b): Lewis Acid Catalyst

The Lewis acid catalyst (b) is desirably selected from a group consisting of aluminum alkyls, aluminum aryls, arylboranes including triarylborane (including substituted aryl and triarylboranes such a tris(pentafluorophenyl)borane), boron halides, aluminum halides, gallium alkyls, gallium aryls, gallium halides, silylium cations and phosphonium cations. Examples of suitable aluminum alkyls include trimethylaluminum and triethylaluminum. Examples of suitable aluminum aryls include triphenyl aluminum and tris(pentafluorophenyl)aluminum. Examples of triarylboranes include those having the following formula:

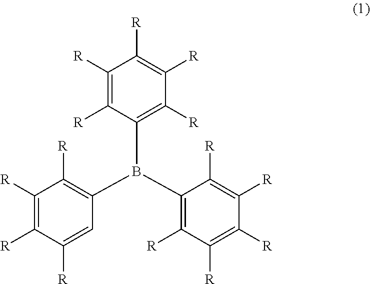

where each R in structure (1) above is independently in each occurrence selected from H, F, Cl and CF₃, a commercially available example being tris(pentafluorophenyl)borane (B(C₆F₅)₃). Examples of suitable boron halides include (CH₃CH₂)₂BCl and boron trifluoride. Examples of suitable aluminum halides include aluminum trichloride. Examples of suitable gallium alkyls include trimethyl gallium. Examples of suitable gallium aryls include tetraphenyl gallium. Examples of suitable gallium halides include trichlorogallium. Examples of suitable silylium cations include (CH₃CH₂)₃Si⁺X⁻ and Ph₃Si⁺X⁻. Examples of suitable phosphonium cations include F—P(C₆F₅)₃⁺X⁻. Preferably the Lewis acid catalyst (b) are selected from arylboranes, arylboranes including triarylborane (including substituted aryl and triarylboranes such a tris(pentafluorophenyl)borane) and/or boron halides. In particular Lewis acid catalyst (b) is selected from tris(pentafluorophenyl)borane (B(C₆F₅)₃), tris(3,5-bis(trifluoromethyl)phenyl)borane, bis(3,5-bis(trifluoromethyl)phenyl)(4-(trifluoromethyl)phenyl)borane, bis(3,5-bis(trifluoromethyl)phenyl)(2,4,6-trifluorophenyl)borane and/or mixtures thereof.

The Lewis acid catalyst (b) is typically present in the composition at a concentration of 10 weight parts per million (ppm) or more, 50 ppm or more, 150 ppm or more, 200 ppm or more, 250 ppm or more, 300 ppm or more, 350 ppm or more 400 ppm or more, 450 ppm or more, 500 ppm or more, 550 ppm or more, 600 ppm or more, 700 ppm or more 750 ppm or more, 1000 ppm or more 1500 ppm or more, 2000 ppm or more, 4000 ppm or more, 5000 ppm or more, even 7500 ppm or more, while at the same time is typically 10,000 or less, 7500 ppm or less, 5000 ppm or less, 1500 ppm or less, 1000 ppm or less, or 750 ppm or less in each case relative to the total weight of the other ingredients/components in the composition.

The required amount of catalyst may be prepared by being dissolved in a suitable organic solvent such as in toluene and/or tetrahydrofuran (THF) and is then delivered to the composition in said solution. The chosen solvent(s) preferably evaporate out of the composition during or after the cure process.

### Component (c): One or More Surfactants

Any suitable surfactant(s) may be utilised in the composition herein. The one or more surfactants (c) may comprise one or more anionic, non-ionic, amphoteric and/or cationic surfactants, and mixtures thereof.

Suitable surfactants (sometimes referred to as “foaming aids”) include silicone polyethers, ethylene oxide polymers, propylene oxide polymers, copolymers of ethylene oxide and propylene oxide, and combinations thereof. If desired, the composition comprises a fluorinated surfactant which may be organic or silicon containing, such as perfluorinated polyethers i.e., those which have repeating units of the formulae:

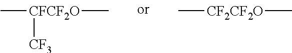

or and mixtures of such units.

Alternatively, the fluorinated surfactant may be a silicon-containing fluorinated surfactant e.g., an organopolysiloxane which contain organic radicals having fluorine bonded thereto, such as siloxanes having repeating units of the formulae:

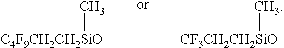

Adding the fluorinated surfactant to the composition herein may be utilised to decrease the cured foam density. In general, increasing the amount of fluorinated surfactant in the composition decreases the density of the foam. This is especially true for slow cure systems, where the surfactant stabilizes bubbles while the network forms and cures.

Anionic surfactants include alkali metal alkyl sulphates sodium lauryl sulfate; fatty alcohol ether sulfates (FAES); alkyl phenol ether sulfates (APES); carboxylic, phosphoric and sulfonic acids and their salt derivatives; alkyl carboxylates; acyl lactylates; alkyl ether carboxylates; n-acyl sarcosinate; n-acyl glutamates; fatty acid-polypeptide condensates; alkali metal sulforicinates; sulfonated glycerol esters of fatty acids, such as sulfonated monoglycerides of coconut oil acids; salts of sulfonated monovalent alcohol esters, such as sodium oleylisethionate; amides of amino sulfonic acids, such as the sodium salt of oleyl methyl tauride; sulfonated products of fatty acids nitriles, such as palmitonitrile sulfonate; sulfonated aromatic hydrocarbons, such as sodium alpha-naphthalene monosulfonate; condensation products of naphthalene sulfonic acids with formaldehyde; sodium octahydroanthracene sulfonate; ether sulphates having alkyl groups of 8 or more carbon atoms; alkylarylsulfonates having 1 or more alkyl groups of 8 or more carbon atoms. sodium dodecyl benzene sulfonate, dioctylsulfosuccinate, sodium polyoxyethylene lauryl ether sulfate, diphenyl sulfonate derivatives, e.g., sodium dodecyl diphenyloxide disulfonate and sodium salt of tert-octylphenoxyethoxypoly(39)ethoxyethyl sulfate.

Anionic surfactants which are commercially available and useful herein include, but are not limited to, POLYSTEP™ A4, A7, A11, A15. A15-30K, A16, A16-22, A18, A13, A17, B1, B3, B5, B11, B12, B19, B20, B22, B23, B24, B25, B27, B29, C-OP3S; ALPHA-STEP™ ML40, MC48; STEPANOL™ MG; all produced by STEPAN CO., Chicago, IL; HOSTAPUR™ SAS produced by HOECHST CELANESE; HAMPOSYL™ C30 and L30 produced by W.R.GRACE & CO., Lexington, MA.

Non-ionic surfactants include polyethoxylates, such as ethoxylated alkyl polyethylene glycol ethers; polyoxyalkylene alkyl ethers; polyoxyalkylene sorbitan esters; polyoxyalkylene esters; polyoxyalkylene alkylphenyl ethers, ethoxylated amides; ethoxylated alcohols; ethoxylated esters; polysorbate esters; polyoxypropylene compounds, such as propoxylated alcohols; ethoxylated/propoxylated block polymers and propoxylated esters; alkanolamides; amine oxides; fatty acid esters of polyhydric alcohols, such as ethylene glycol esters, diethylene glycol esters, propylene glycol esters, glyceryl esters, polyglyceryl fatty acid esters, sorbitan esters, sucrose esters and glucose esters. Commercial non-ionic surfactants include, for the sake of example, TERGITOL™ TMN-6, TERGITOL™ 15540, TERGITOL™ 1559, TERGITOL™ 15512, TERGITOL™ 15S15 and TERGITOL™ 15820, and TRITON™ X405 produced by The Dow Chemical Company of Midland, Michigan; BRIJ™ 30 and BRIJ™ 35 produced by Croda (UK); MAKON™ 10 produced by STEPAN COMPANY, (Chicago, IL); and ETHOMID™ O/17 produced by Akzo Nobel Surfactants (Chicago, IL).

Amphoteric surfactants include glycinates, betaines, sultaines and alkyl aminopropionates. These include cocoamphglycinate, cocoamphocarboxy-glycinates, cocoamidopropylbetaine, lauryl betaine, cocoamidopropylhydroxysultaine, laurylsulataine and cocoamphodipropionate.

Amphoteric surfactants which are commercially available and useful herein include, for the sake of example, REWOTERIC™ AM TEG, AM DLM-35, AM B14 LS, AM CAS and AM LP produced by SHEREX CHEMICAL CO., Dublin, OH.

Cationic surfactants include aliphatic fatty amines and their derivatives, such as dodecylamine acetate, octadecylamine acetate and acetates of the amines of tallow fatty acids; homologues of aromatic amines having fatty chains, such as dodecylanalin; fatty amides derived from aliphatic diamines, such as undecylimidazoline; fatty amides derived from disubstituted amines, such as oleylaminodiethylamine; derivatives of ethylene diamine; quaternary ammonium compounds, such as tallow trimethyl ammonium chloride, dioctadecyldimethyl ammonium chloride, didodecyldimethyl ammonium chloride and dihexadecyldimethyl ammonium chloride; amide derivatives of amino alcohols, such as beta-hydroxyethylstearyl amide; amine salts of long chain fatty acids; quaternary ammonium bases derived from fatty amides of di-substituted diamines, such as oleylbenzylaminoethylene diethylamine hydrochloride; quaternary ammonium bases of the benzimidazolines, such as methylheptadecyl benzimidazole hydrobromide; basic compounds of pyridinium and its derivatives, such as cetylpyridinium chloride; sulfonium compounds, such as octadecylsulfonium methyl sulphate; quaternary ammonium compounds of betaine, such as betaine compounds of diethylamino acetic acid and octadecylchloromethyl ether; urethanes of ethylene diamine, such as the condensation products of stearic acid and diethylene triamine; polyethylene diamines and polypropanolpolyethanol amines.

Cationic surfactants which are commercially available and useful herein include, for the sake of example, ARQUAD™ T27W, ARQUAD™ 16-29, ARQUAD™ C-33, ARQUAD™ T50, ETHOQUAD™ T/13 ACETATE, all manufactured by Akzo Nobel Surfactants (Chicago, IL). The one or more surfactants (c) will usually be present in the composition herein at levels of from 0.1 wt. % to 15 wt. %, alternatively, from 0.1% to 11 wt. %, of the composition.

### Component (d): A Compound Comprising an Average of at Least Two, Alternatively at Least Three Silicon Bonded Hydrogen Groups Per Molecule

The composition herein also comprises component (d) a compound comprising an average of at least two, alternatively at least three silicon bonded hydrogen groups per molecule which is utilised to create a chemical blowing agent as the composition cures. In this case, component (d) comprises an average of at least two, alternatively at least three silicon bonded hydrogen groups with at least one silicon bonded hydrogen group (Si—H) group which will react with the alkoxy groups of component (a), catalysed by component (b) the Lewis acid catalyst to produce an Si—O—Si bond and an alkane byproduct which functions as a chemical blowing agent, i.e.

≡Si-H+RO-Si≡→≡Si—O—Si≡+RH

In the event that the cure and foaming processes are designed to take place at or about room temperature, the alkoxy groups in component (a) are preferably methoxy, ethoxy, propoxy and/or butoxy groups, such that when the above reaction takes place alkanes which are gaseous at room temperature are generated and therefore function as chemical blowing agents to create a foam as the composition cures. However, in the event that the reaction process is designed to commence at an alternate e.g., elevated temperature, an alternative alkoxy group may be selected such that the alkanes produced become gaseous at or around the desired temperatures of cure.

Each compound comprising an average of at least two, alternatively at least three silicon bonded hydrogen groups per molecule (d) contains one, preferably more than one, Si—H bond. The Si—H bond is typically part of polysilane (molecule containing multiple Si—H bonds) or polysiloxane. Component (d) compounds containing multiple Si—H bonds are desirable as crosslinkers in compositions herein as well as being involved in the generation of the chemical blowing agents because they are capable of reacting with multiple methoxy groups via the reaction indicated above. The compound comprising an average of at least two, alternatively at least three silicon bonded hydrogen groups per molecule (d) can be polymeric. The compound comprising an average of at least two, alternatively at least three silicon bonded hydrogen groups per molecule (d) can be linear and/or branched and can be a polysilane, a polysiloxane or a combination of polysilanes and polysiloxanes. Desirably, the compound comprising an average of at least two, alternatively at least three silicon bonded hydrogen groups per molecule (d) is a polysiloxane molecule with two or more Si—H bonds, in which case each Si—H bond is on the silicon atom of an M-type or D-type siloxane unit. The polysiloxane can be linear and comprise only M type and D type units. Alternatively, the polysiloxane can be branched and contain T (—SiO_{3/2}) type and/or Q (SiO_{4/2}) type units. Examples of suitable compounds comprising an average of at least two, alternatively at least three silicon bonded hydrogen groups per molecule (d) include pentamethyldisiloxane, bis(trimethylsiloxy)methyl-silane, tetramethyldisiloxane, tetramethycyclotetrasiloxane, D^{H} containing poly(dimethylsiloxanes) such as DOWSIL™ MH 1107 Fluid having a viscosity of 30 mPa·s at 25° C. (datesheet) from Dow Silicones Corporation, and Si—H dimethyl terminated poly(dimethylsiloxane) such as those available from Gelest under the tradenames: DMS-HM15, DMS-H03, DMS-H25, DMS-H31, and DMS-H41.

The concentration of the compound comprising an average of at least two, alternatively at least three silicon bonded hydrogen groups per molecule (d) when present is typically sufficient to provide a molar ratio of Si—H groups to alkoxy groups that is greater than or equal to (≥) 0.2:1, alternatively from 0.2:1 to 5:1, alternatively 0.5:1 to 5:1, alternatively 0.5:1 to 4.5:1, alternatively 0.5:1 to 4.0:1, alternatively 0.5:1 to 3.5:1, alternatively 0.5:1 to 3.0:1, alternatively 0.5:1 to 2.5:1, alternatively 0.7:1 to 2.0:1, or alternatively 1.0:1 to 2.

Either the component (a) or component (d) can serve as crosslinkers in the reaction. A crosslinker has at least two reactive groups per molecule and reacts with two different molecules through those reactive groups to cross link those molecules together. Increasing the linear length between reactive groups in a crosslinker tends to increase the flexibility in the resulting crosslinked product. In contrast, shortening the linear length between reactive groups in a crosslinker tends to reduce the flexibility of a resulting crosslinked product. Generally, to achieve a more flexible crosslinked product a linear crosslinker is desired and the length between reactive sites is selected to achieve desired flexibility. To achieve a less flexible crosslinked product, shorter linear crosslinkers or even branched crosslinkers are desirable to reduce flexibility between crosslinked molecules.

Typically, component (d) is present in the composition in an amount of from 5 wt. % to 90 wt. % based on the weight of the composition. The broad range is required in order to meet the above molar ratios. Where component (d) is for example a molecule with an average of much greater than two Si—H groups per molecule is used the composition may comprise, for example component (d) in an amount of from 5 from wt. % to 50 wt. %, alternatively from 5 wt. % to 35 wt. %, alternatively from 5 wt. % to 20 wt. % based on the weight of the composition. However, in cases where, e.g., Si—H dimethyl terminated polydimethylsiloxanes are utilised, such compound only averages two Si—H groups per molecule and in order to meet the above molar ratios significantly more of component (d) is required in the composition e.g., from 40 wt. % to 90 wt. %, alternatively from 40 wt. % to 85 wt. %, alternatively from 50 from wt. % to 85 wt. %. Mixtures of the above will need to be present in suitable amounts dependent on the different amounts of the component (d) molecules utilised to meet the molar ratios discussed above.

The composition herein may optionally comprise a physical blowing agent, a cure inhibitor or both a physical blowing agent and a cure inhibitor.

### Physical Blowing Agent

Whilst the foam prepared from the composition herein is mainly, if not exclusively generated by chemical means, i.e., the generation of gaseous alkanes as described above, however if desired, the composition herein may, optionally, also comprise a physical blowing agent.

When the foams herein are to be partially physically blown one or more physical blowing agents are provided as an additional source for the gas that leads to the formation of the foam. Physical blowing agents undergo a phase change from a liquid to a gaseous state during exposure to atmospheric pressure and a temperature of greater or equal to (≥) 10° C., alternatively ≥20° C., alternatively ≥30° C., alternatively ≥40° C., alternatively ≥50° C., alternatively ≥60° C., alternatively ≥70° C., alternatively ≥80° C., alternatively ≥90° C., alternatively ≥100° C. The boiling point temperature generally depends upon the particular type of physical blowing agent.

The amount of physical blowing agent utilized, when present, can vary depending on the desired outcome. For example, the amount of physical blowing agent can be varied to tailor final foam density and foam rise profile.

Useful physical blowing agents which may be utilised, if required, include hydrocarbons, such as pentane, hexane, halogenated, more particularly chlorinated and/or fluorinated, hydrocarbons, for example dichloromethane (methylene chloride), trichloromethane (chloroform), trichloroethane, chlorofluorocarbons, hydrochlorofluorocarbons (HCFCs), ethers, ketones and esters, for example methyl formate, ethyl formate, methyl acetate or ethyl acetate, in liquid form or air, nitrogen or carbon dioxide as gases. In certain embodiments, when present, the physical blowing agent comprises a compound selected from the group consisting of propane, butane, isobutane, isobutene, isopentane, dimethylether or mixtures thereof. In many embodiments, the blowing agent comprises a compound that is inert. These and other suitable physical blowing agents are described in U.S. Pat. Nos. 5,283,003A, 6,476,080B2, 6,599,946B2, EP3135304A1, and WO2018095760A1, which are incorporated herein by reference.

In various embodiments, the physical blowing agent when present, comprises a hydrofluorocarbon (HFC). “Hydrofluorocarbon” and “HFC” are interchangeable terms and refer to an organic compound containing hydrogen, carbon, and fluorine. The compound is substantially free of halogens other than fluorine.

Examples of suitable HFCs include aliphatic compounds such as 1,1,1,3,3-pentafluoropropane (HFC-245fa), 1,1,1,3,3-pentafluorobutane (HFC-365mfc), 1-fluorobutane, nonafluorocyclopentane, perfluoro-2-methylbutane, 1-fluorohexane, perfluoro-2,3-dimethylbutane, perfluoro-1,2-dimethylcyclobutane, perfluorohexane, perfluoroisohexane, perfluorocyclohexane, perfluoroheptane, perfluoroethylcyclohexane, perfluoro-1,3-dimethyl cyclohexane, and perfluorooctane; as well as aromatic compounds such as fluorobenzene, 1,2-difluorobenzene; 1,4-difluorobenzene, 1,3-difluorobenzene; 1,3,5-trifluorobenzene; 1,2,4,5-tetrafluorobenzene, 1,2,3,5-tetrafluorobenzene, 1,2,3,4-tetrafluorobenzene, pentafluorobenzene, hexafluorobenzene, and 1-fluro-3-(trifluoromethyl)benzene. In certain embodiments, HFC-365mfc and HFC-245fa may be preferred due to their increasing availability and ease of use, with HFC-365mfc having a higher boiling point than HFC-245fa which may be useful in certain applications. For example, HFCs having a boiling point higher than 30° C., such as HFC-365mfc, may be desirable because they do not require liquefaction during foam processing. In specific embodiments, when present, the physical blowing agents may comprise or consist of 1,1,1,3,3-pentafluoropropane (HFC-245fa).

The amount of physical blowing agent utilized, when present, can vary depending on the desired outcome. For example, the amount of physical blowing agent can be varied to tailor final foam density and foam rise profile.

### Cure Inhibitor

The composition may also include a suitable cure inhibitor, for example a suitable amine compound, which can complex with the Lewis acid catalyst (b) to inhibit the catalytic activity thereof in the present composition over a desired temperature range but will dissociate from the Lewis acid at a desired temperature above the range so as to rapidly (within 10 minutes or less, preferably 5 minutes or less, more preferably two minutes or less) enable the composition to cure. The temperature range over which the cure inhibitor is designed to form a complex with the Lewis acid catalyst (b) and inhibit cure is dependent on the intended application for the foam product. When present the cure inhibitor is selected accordingly.

Any suitable amine may be utilised as the cure inhibitor when present. For example, the cure inhibitor(s) may include but are not limited to arylamines, e.g. triarylamines, aniline, 4-methylaniline, 4-fluoroaniline, 2-chloro-4-fluoroaniline, diphenylamine, Di(n-butyl)aniline, diphenylmethylamine, triphenylamine, 1-naphthylamine, 2-naphthylamine, 1-aminoanthracene, 2-aminoanthracene, 9-aminoanthracene, β-aminostyrene, 1,3,5-hexatrien-1-amine, N,N-dimethyl-1,3,5-hexatrien-1-amine, 3-amino-2-propenal and 4-amino-3-buten-2-one. The cure inhibitor may additionally or alternatively comprise one or more alkylamines such as, for example, butylamine, pentylamine, hexylamine, octylamine, dipropylamine, dibutylamine, dihexylamine, trimethylamine, triethylamine, tripropylamine, tributylamine, tripentylamine, trihexylamine, triheptalamine, trioctylamine and trinonylamine and/or mixtures thereof.

When present, the selection of inhibitor to be used may depend on the intended cure temperature, typically it is preferred to use arylamines for low temperature cure compositions e.g., less than 100° C. and whereas either arylamines and/or alkylamines may be used for compositions when higher temperature cure is intended e.g., for temperatures greater than about 150° C.

When present, the concentration of cure inhibitor (amine) in the composition herein is at least a molar equivalent (i.e., a molar ratio of 1:1) to the concentration of Lewis acid catalyst (b) so as to be able to complex with and inhibit all of the Lewis acid catalyst (b) at room temperature. The concentration of cure inhibitor (amine) can exceed the molar concentration of Lewis acid catalyst (b), i.e., up to about a molar ratio of 3:1 e.g., the molar ratio of the Lewis acid catalyst (b): cure inhibitor may be from 1:1 to 1:3.

In cases where the Lewis acid catalyst (b) is introduced into the composition in solution as described above, e.g. when, for the sake of example, tris(pentafluorophenyl)borane, and/or tris(3,5-bis(trifluoromethyl)phenyl)borane are used as the Lewis acid catalyst (b), if cure inhibitor is required, it may be introduced into the catalyst solution in the desired molar ratio with the Lewis acid catalyst (b) to enable a Lewis acid catalyst (b)/cure inhibitor complex to be formed in said solution before mixing with the other components.

The silicone rubber foam composition as described herein may optionally further comprise additional ingredients or components (hereafter referred to as “additional additives”). Examples of additional additives include, but are not limited to, stabilisers, such as heat stabilisers; adhesion promoters; colorants, including dyes and pigments; antioxidants; flame retardants; flow control additives and/or reinforcing and/or non-reinforcing (sometimes referred to as extending) fillers.

The one or more additives can be present in a suitable wt. % of the composition. When present the additive may be present in an amount of up to about 10 or even 15 wt. % based on the understanding that the total wt. % of the composition is 100 wt. %. One of skill in the art can readily determine a suitable amount of additive depending, for example, on the type of additive and the desired outcome. Certain optional additives are described in greater detail below.

The additional additives include heat stabilizers which may include, for example, metal compounds such as red iron oxide, yellow iron oxide, ferric hydroxide, cerium oxide, cerium hydroxide, lanthanum oxide, copper phthalocyanine, aluminum hydroxide, fumed titanium dioxide, iron naphthenate, cerium naphthenate, cerium dimethylpolysilanolate and acetylacetone salts of a metal chosen from copper, zinc, aluminum, iron, cerium, zirconium, titanium and the like. The amount of heat stabilizer present in a composition may range from 0.01 to 1.0 wt. % of the total composition. The additional additives include pigments and/or colorants which may be added if desired. The pigments and/or colorants may be coloured, white, black, metal effect, and luminescent e.g., fluorescent and phosphorescent.

Suitable white pigments and/or colorants include titanium dioxide, zinc oxide, lead oxide, zinc sulfide, lithophone, zirconium oxide, and antimony oxide.

Suitable non-white inorganic pigments and/or colorants include, but are not limited to, iron oxide pigments such as goethite, lepidocrocite, hematite, maghemite, and magnetite black iron oxide, yellow iron oxide, brown iron oxide, and red iron oxide; blue iron pigments; chromium oxide pigments; cadmium pigments such as cadmium yellow, cadmium red, and cadmium cinnabar; bismuth pigments such as bismuth vanadate and bismuth vanadate molybdate; mixed metal oxide pigments such as cobalt titanate green; chromate and molybdate pigments such as chromium yellow, molybdate red, and molybdate orange; ultramarine pigments; cobalt oxide pigments; nickel antimony titanates; lead chrome; carbon black; lampblack, and metal effect pigments such as aluminum, copper, copper oxide, bronze, stainless steel, nickel, zinc, and brass.

Suitable organic non-white pigments and/or colorants include phthalocyanine pigments, e.g. phthalocyanine blue and phthalocyanine green; monoarylide yellow, diarylide yellow, benzimidazolone yellow, heterocyclic yellow, DAN orange, quinacridone pigments, e.g. quinacridone magenta and quinacridone violet; organic reds, including metallized azo reds and nonmetallized azo reds and other azo pigments, monoazo pigments, diazo pigments, azo pigment lakes, β-naphthol pigments, naphthol AS pigments, benzimidazolone pigments, diazo condensation pigment, isoindolinone, and isoindoline pigments, polycyclic pigments, perylene and perinone pigments, thioindigo pigments, anthrapyrimidone pigments, flavanthrone pigments, anthanthrone pigments, dioxazine pigments, triarylcarbonium pigments, quinophthalone pigments, and diketopyrrolo pyrrole pigments.

Typically, the pigments and/or colorants, when particulates, have average particle diameters in the range of from 10 nm to 50 μm, preferably in the range of from 40 nm to 2 μm. The pigments and/or colorants when present are present in the range of from 2, alternatively from 3, alternatively from 5 wt. % of the composition to 20, alternatively to 10 wt. % of the composition.

The additional additives may also include flame retardants. Examples of flame retardants include aluminum trihydrate, magnesium hydroxide, chlorinated paraffins, hexabromocyclododecane, triphenyl phosphate, dimethyl methylphosphonate, tris(2,3-dibromopropyl) phosphate (brominated tris), and mixtures or derivatives thereof.

The additional additives may also include reinforcing and/or non-reinforcing (sometimes referred to as extending) fillers. Examples of finely divided, reinforcing fillers include high surface area fumed and precipitated silicas including rice hull ash and to a degree calcium carbonate. Examples of finely divided non-reinforcing fillers include crushed quartz, diatomaceous earths, barium sulphate, iron oxide, titanium dioxide and carbon black, talc, and wollastonite. Other fillers which might be used alone or in addition to the above include carbon nanotubes, e.g., multiwall carbon nanotubes aluminite, calcium sulphate (anhydrite), gypsum, calcium sulphate, magnesium carbonate, clays such as kaolin, aluminum trihydroxide, magnesium hydroxide (brucite), graphite, copper carbonate, e.g., malachite, nickel carbonate, e.g., zarachite, barium carbonate, e.g., witherite and/or strontium carbonate e.g., strontianite. Further alternative fillers include aluminum oxide, silicates from the group consisting of olivine group; garnet group; aluminosilicates; ring silicates; chain silicates; and sheet silicates.

The filler if present, may optionally be surface treated with a treating agent. Treating agents and treating methods are understood in the art. The surface treatment of the filler(s) is typically performed, for example with a fatty acid or a fatty acid ester such as a stearate, or with organosilanes, organosiloxanes, or organosilazanes such as hexaalkyldisilazane e.g., hexamethyldisilazane (HMDZ) or short chain siloxane diols. Generally, the surface treatment renders the filler(s) hydrophobic and therefore easier to handle and obtain a homogeneous mixture with the other components in the composition. Silanes such as R⁷ₑSi(OR⁶)₄₋ₑ where R⁷ is a substituted or unsubstituted monovalent hydrocarbon group of 6 to 20 carbon atoms, for example, alkyl groups such as hexyl, octyl, dodecyl, tetradecyl, hexadecyl, and octadecyl, and aralkyl groups such as benzyl and phenylethyl, R⁶ is an alkyl group of 1 to 6 carbon atoms, and subscript “e” is equal to 1, 2 or 3, may also be utilized as the treating agent for fillers.

In certain embodiments, the composition may comprise hollow particles, which can be useful for contributing to porosity and/or overall void fraction of the foam e.g., low density (e.g., 25 kg/m³) pre-expanded polymeric spheres containing hydrocarbons having low boiling points, such that upon heating, said hydrocarbons evaporate, thereby functioning as a foaming agent leaving behind the polymeric beads. Such hollow beads are commercially available e.g., Expancel™ 920 DET 40 d25 supplied by Nouryon Chemicals.

For the avoidance of doubt, it is to be understood that in all other references to weight % (wt. %) of the composition in this disclosure, the total wt. % of all compositions is in all instances is 100%, with the exception of the catalyst/inhibitor which is added to the remainder of the composition which is calculated to add up to 100 wt. %.

As previously indicated, there is also provided a method of making a silicone rubber foam composition comprising:

Mixing a silicone rubber foam composition comprising
(a) one or more organosilicon compounds having an average of at least two silicon bonded alkoxy groups per molecule selected from one or more silicone resins and/or silicone resin intermediates;
(b) a Lewis acid catalyst;
(c) one or more surfactants; and
(d) one or more organopolysiloxane polymers having an average of at least two, alternatively at least three silicon bonded hydrogen groups per molecule;
and causing foaming whilst the composition cures.

As previously indicated the above composition may optionally comprise a physical blowing agent, a cure inhibitor or both a physical blowing agent and a cure inhibitor as well as numerous additional additives utilised dependent on the application for which the foam is to be used. When both a physical blowing agent and a cure inhibitor, the temperature at which the physical blowing agent becomes gaseous may be lower, approximately the same or higher than the temperature at which point the cure/inhibitor complex breaks down allowing cure to commence. In one embodiment the temperature may be approximately the same (e.g., within 15° C. of each other).

As will be seen from the above, the foams described herein are chemically blown but may alternatively be chemically and physically blown. For, example in the case of chemically blown compositions the ingredients/components of the composition can be introduced in any suitable order into a suitable container and mixed for a predetermined period of time at a suitable temperature e.g., between room temperature (approximately 23 to 25° C.) to 100° C., alternatively from room temperature to 75° C. The temperature needs to be carefully chosen, especially if a cure inhibitor (amine) is being utilised. This is because the selected temperature needs to be able to cause the dissociation of the catalyst and cure inhibitor (when the latter is present) as well as the cure process and the release of the alkane gas blowing agents which create the foaming as the composition cures.

In one embodiment, the process may comprise the steps of

Preparing a Lewis acid catalyst (b) solution by mixing the catalyst in a suitable solvent or combination of solvents, or if the optional cure inhibitor, e.g. one or more amines as previously described, is present in the composition, preparing a Lewis acid catalyst (b)/cure inhibitor complex solution by mixing the catalyst and inhibitor in a suitable molar ratio in a suitable solvent or combination of solvents, as described above, to form the Lewis acid catalyst (b)/cure inhibitor complex solution; then
mixing said catalyst solution or Lewis acid catalyst (b)/cure inhibitor complex solution with components (a), (c), (d) and optionally physical blowing agent etc. to form a silicone rubber foam composition as hereinbefore described.

Alternatively, when the cure inhibitor (e.g., amine) is present, it is possible to prepare the Lewis acid catalyst (b)/cure inhibitor complex in the presence of the other components of the composition provided the Lewis acid catalyst (b) does not catalyze the reaction prior to complex formation.

When present. the cure inhibitor enhances shelf stability of the composition, typically at low temperatures e.g., room temperature and the selection of cure inhibitor and Lewis acid catalyst (b) can be utilised to tune/select a desired (e.g., elevated) temperature above which the composition will cure after the breakdown of the Lewis acid catalyst (b)/cure inhibitor complex. This temperature may be pre-determined based on the application for which the foam is to be used and may, for the sake of example, be 50° C. or 60° C. or 80° C. or higher.

When the cure inhibitor is present and has formed a complex with the Lewis acid catalyst (b), the ability to heat is important as the sample can be heated up quickly to initiate the cure reaction so that the mixture becomes viscous enough to hold bubbles. Any suitable mixer can be utilised to mix the composition as and when required. Suitable mixers may include, merely for the sake of example suitable speedmixers, Oakes mixers, Hobart mixers, lightening mixers and change can mixers. When the foams are additionally relying on physical blowing agents to foam the composition, the Lewis acid cure catalyst (b) (or Lewis acid cure catalyst (b)/cure inhibitor complex solution) and physical blowing agent are typically introduced into the composition as the last two ingredients/components.

The silicone rubber foam compositions as described herein produce open cell and/or closed cell silicone rubber foams. The foam density may be measured by any suitable method such as via the Archimedes principle, using a balance and density kit, and following standard instructions associated therewith. A suitable balance is a Mettler-Toledo XS205DU balance with density kit.

The foam may have a density of from 0.01 grams per cubic centimeter g/cm³ to 5 g/cm³, alternatively from 0.05 g/cm³ to 2.5 g/cm³ alternatively from 0.1 g/cm³ to 2.0 g/cm³, alternatively from 0.1 g/cm³ to 1.5 g/cm³.

If the density is too high, the foam may be too heavy or stiff for certain applications. If density is too low, the foam may lack desired structural integrity for certain applications.

The average pore size can be determined via any suitable method such as in accordance with ATSM method D3576-15 optionally with the following modifications:
(1) image a foam using optical or electron microscopy rather than projecting the image on a screen; and
(2) scribe a line of known length that spans greater than 15 cells rather than scribing a 30 mm line.

The silicone foam compositions as described herein generally have pores that are uniform in size and/or shape. Typically, the foam has an average pore size of between 0.001 mm and 5 mm, alternatively between 0.001 mm and 2.5 mm, alternatively between 0.001 mm and 1 mm, alternatively between 0.001 mm and 0.5 mm, alternatively between 0.001 mm and 0.25 mm, alternatively between 0.001 mm and 0.1 mm, and alternatively between 0.001 mm and 0.05 mm.

The compositions, foams, and methods described herein are useful for a variety of end applications. Examples of suitable applications include space filling applications, automotive applications (e.g., for control modules), and the like. The foams can be used to at least partially cover or encapsulate articles, such as batteries and other electronic components. The foams can also be used for thermal insulation.

### EXAMPLES

Compositions were generated utilizing different types and amounts of components. These are detailed below. All amounts are in wt. % unless indicated otherwise. All viscosities are measured at 25° C. unless otherwise indicated. The viscosity of individual ingredients/components may be determined by any suitable method such as using a Brookfield® rotational viscometer with spindle LV-3 (designed for viscosities in the range between 200-400,000 mPa·s) or a Brookfield® rotational viscometer with spindle LV-1 (designed for viscosities in the range between 15-20,000 mPa·s) for viscosities less than 200 mPa·s and adapting the speed according to the polymer viscosity.

A series of compositions for examples and a comparative example were prepared based on the compositions identified in Table 1a below (wt. % excluding catalyst solutions (Ex. 1-3) and/or catalyst/cure inhibitor complex solution (C.1)):

TABLE 1a

| Ingredient | Ex. 1 | Ex. 2 | Ex. 3 | C. 1 |
|---|---|---|---|---|
| DOWSIL ™ US-CF-2403 | 10.5 | — | — | — |
| Resin (wt. %) | | | | |
| DOWSIL ™ 3074 | — | 3.3 | — | — |
| Intermediate (wt. %) | | | | |
| DOWSIL ™ 3037 | — | — | 9.8 | — |
| Intermediate (wt. %) | | | | |
| Tetraethyl orthosilicate | — | — | — | 55.6 |
| (TEOS) (wt. %) | | | | |
| Surfactant (wt. %) | 6 | 10 | 10 | — |
| DOWSIL ™ MH 1107 Fluid | 4.0 | 2.8 | 9.2 | 44.4 |
| Dimethyl hydrogen terminated | 79.5 | — | — | — |
| polydimethylsiloxane | | | | |
| (M^{H}D₉₇M^{H}) (wt. %) | | | | |
| Gelest ™ DMS-H31 (wt. %) | — | 83.9 | 71.0 | — |

In C.1 N-methyldiphenylamine, (Ph₂NCH₃) was used as a cure inhibitor. It was prepared in a solution in toluene with the Lewis acid catalyst (b) with a 1:1 Lewis acid catalyst (b): cure catalyst molar ratio.

TABLE 1b
Catalyst concentration introduced in toluene solution
and ratio of Catalyst to inhibitor in Lewis Acid catalyst/cure
inhibitor complex solution when N-methyldiphenylamine,
(Ph₂NCH₃) was used as a cure inhibitor

| Ingredient | Ex. 1 | Ex. 2 | Ex. 3 | C. 1 |
|---|---|---|---|---|
| Tris(pentafluorophenyl)borane, | 400 | 1000 | 1000 | 400 |
| B(C₆F₅)₃ ppm | | | | |
| Catalyst:Cure Inhibitor molar ratio | — | — | — | 1:1 |

Three methoxy functional silicone resins commercially available from Dow Silicones Corporation were used as methoxy resins in Table 1a:

DOWSIL™ US-CF-2403 Resin is a methyl-methoxy functional, solventless and low molecular weight liquid siloxane. It has a viscosity of up to about 35 mPa·s at 25° C. (datasheet) and a weight average molecular weight of less than 1000 Da (datasheet).

DOWSIL™ 3074 Intermediate is a methoxy-functional, solventless liquid silicone resin. It has a 15 to 18 wt. % methoxy content, an average viscosity of about 120 mPa·s at 25° C. and weight average molecular weight of between 1000 and 1500 Da (datasheet).

DOWSIL™ 3037 Resin Intermediate is a methoxy-functional, solventless liquid silicone resin. It has a 15 to 18 wt. % methoxy content, an average viscosity of about 15 mPa·s at 25° C. and weight average molecular weight of between 800 and 1300 Da (datasheet).

The surfactant used in the present examples was a commercial surfactant sold as DOWSIL™ 3-9727 Profoamer by Dow Silicones Corporation of Midland, Michigan.

DOWSIL™ MH 1107 Fluid is a trimethyl terminated polymethylhydrogen siloxane having a viscosity of about 30 mPa·s at 25° C. (datasheet) commercially available from Dow Silicones Corporation.

Gelest™ DMS-H31, is a dimethyl hydrogen terminated polydimethylsiloxane having a viscosity of 1,000 mPa·s at 25° C. (Supplier information) from Gelest Inc;

In the case of the foams in Table 1a, Ex. 1 to 3 were all solely chemically blown to produce the resulting foams, whilst comparatives C.1 were chemically and physically blown.

In the examples of Table 1, catalyst (b) utilised, i.e., tris(pentafluorophenyl)borane, B(C₆F₅)₃ was introduced into the composition as a Lewis acid catalyst (b) solution in toluene in Ex. 1 to 3 and in a Lewis acid catalyst (b)/cure inhibitor complex solution for C.1.

The Lewis acid catalyst (b) solution was prepared by dissolving designated amounts of catalyst in toluene. The Lewis acid catalyst (b)/cure inhibitor complex solution was prepared by dissolving designated amounts of the selected catalyst and an optional cure inhibitor N-Methyldiphenylamine (Ph₂NCH₃) (often referred to as MDPA) in toluene in a Lewis acid catalyst: cure inhibitor molar ratio of 1:1. This enabled catalyst and cure inhibitor to interact and form a complex to inhibit catalytic activity until heated, before introduction into the composition.

### Preparation of Ex. 1, 2 and 3 (Chemically Blown Foams)

For Ex. 1, 2 and 3, the organopolysiloxane polymers having an average of at least two, alternatively at least three silicon bonded hydrogen groups per molecule were first speed-mixed, and about 50 wt. % of the total composition of the resulting mixture was pre-heated in a 50° C. oven. The catalyst solution, surfactant, methoxy-functionalized silicone resin used, and room-temperature mixture of organopolysiloxane polymers having an average of at least two, alternatively at least three silicon bonded hydrogen groups per molecule mixture, and 50° C. mixture of same were added in sequence to a speedmix cup. The sample was subsequently speed-mixed at 3000 rpm for 30 seconds (s) and placed into a 50° C. water bath. 30 min after the cease of bubble generation, the sample was transferred to a 50° C. oven for complete cure.

### Preparation of C.1 (Comparative—Surfactant-Free Chemically Blown Foam)

The catalyst solution, TEOS, and DOWSIL™ MH 1107 Fluid were added in sequence to a speedmix cup, which was subsequently mixed using the speedmixer at 3000 rpm for 30 s. The sample was left at room temperature for foaming.

### Measurement Information

The cure times of Ex. 1 to 3 were measured by a digital stopwatch and defined as the time when gas generation ceased and the sample stopped flowing.

### Density Measurement

Foam densities were measured using a balance (Mettler-Toledo XS205DU) equipped with a density measurement kit based on Archimedes' principle. The weight of a sample (m₀) in air was first measured, after which the balance was tared without removing the sample. The weight of the sample (−m₁) in water (ρ₀=1 g/cc) was then measured.

$$ρ = \frac{{m}_{0}}{- {m}_{1}} \times {ρ}_{0}$$

TABLE 2
Cure Time and Properties of Foams

| Tested Property | Ex. 1 | Ex. 2 | Ex. 3 | C. 1 |
|---|---|---|---|---|
| Cure time at 50° C. (min) | 2.3 | Instantaneous* | 0.7 | — |
| Density (g/cc) | 0.40 | 0.44 | 0.25 | 0.29 |
| Foam morphology (closed | Mixed | Mixed | Mixed | N/A |
| or open cells) | | | | |

*The foaming process finished before timing started.

C.1 was prepared using DOWSIL™ MH 1107 Fluid and tetraethyl orthosilicate (TEOS) using MDPA as a cure inhibitor to tune the reaction kinetics. However, unlike Ex. 1-3 herein comparative C.1 did not comprise a surfactant. The densities of resultant chemically blown silicone foams of Ex. 1 to 3 using tris(pentafluorophenyl)borane (B(C₆F₅)₃ as catalyst were comparable to those of C.1, but it was found that the use of a surfactant in each of Ex. 1-3 helped stabilize the cellular structure before the composition was fully cured and scanning electron microscope analysis (SEM) results indicated that Ex. 1, 2 and 3 had significantly improved regularity of the cell structure of their respective foams than comparative C.1. It was also found that increased viscosities of the compositions of Ex. 1, Ex. 2 and Ex. 3 were beneficial for tuning both cure kinetics and the cell structure with the working times of Ex. 1, 2 and 3 making the compositions easier to handle.

It will be appreciated that as alkanes are generated as chemical blowing agents for the Examples herein, the generation of the foam is safer than when using the previously preferred hydrogen gas as foaming agent because of the narrower explosive limits of alkanes. Furthermore, it will be appreciated that use of expensive platinum-based catalysts and hydrosilylation cure processes are avoided herein. Avoiding the need for such catalysts negates the need to use such expensive catalysts but also avoids discoloration and formation of colloidal platinum particles over time and the catalysts used herein do not suffer from being poisoned in the presence of impurities, such as nitrogen and sulfur-containing heterocyclics unlike platinum catalysts.

1. A silicone rubber foam composition comprising:
(a) one or more organosilicon compounds having an average of at least two silicon bonded alkoxy groups per molecule selected from one or more silicone resins and/or silicone resin intermediates;
(b) a Lewis acid catalyst;
(c) one or more surfactants; and
(d) one or more organopolysiloxane polymers having an average of at least two, optionally at least three silicon bonded hydrogen groups per molecule.

2. The silicone rubber foam composition in accordance with claim 1, wherein component (a) has a weight average molecular weight of from 3,000 to 50,000 Da. determined in Daltons using triple-detector gel permeation chromatography and a single polystyrene standard.

3. The silicone rubber foam composition in accordance with claim 2, wherein component (a) is a silicone resin having a weight average molecular weight of from 300 to 3,000 Da. determined in Daltons using triple-detector gel permeation chromatography and a single polystyrene standard.

4. The silicone rubber foam composition in accordance with claim 1, wherein component (a) is a silicone resin comprising alkoxy groups present in an amount of from 2 to 50 wt. % of the silicone resin.

5. The silicone rubber foam composition in accordance with claim 1, wherein component (b) comprises one or more arylboranes or boron halides or a mixture thereof.

6. The silicone rubber foam composition in accordance with claim 5, wherein component (b) is selected from tris(pentafluorophenyl)borane, tris(3,5-bis(trifluoromethyl)phenyl)borane, bis(3,5-bis(trifluoromethyl)phenyl)(4-(trifluoromethyl)phenyl)borane, bis(3,5-bis(trifluoromethyl)phenyl)(2,4,6-trifluorophenyl)borane or a mixture thereof.

7. The silicone rubber foam composition in accordance with claim 1, wherein component (c) is or comprises a silicone fluorinated surfactant or an organic fluorinated surfactant.

8. The silicone rubber foam composition in accordance with claim 1, additionally comprising a physical blowing agent, a cure inhibitor or both a physical blowing agent and a cure inhibitor.

9. The silicone rubber foam composition in accordance with claim 8, wherein the cure inhibitor is present and is selected from one or more arylamines and/or alkylamines.

10. The silicone rubber foam composition in accordance with claim 9, comprising one or more cure inhibitors selected from triarylamines aniline, 4-methylaniline, 4-fluoroaniline, 2-chloro-4-fluoroaniline, diphenylamine, diphenylmethylamine, triphenylamine, 1-naphthylamine, 2-naphthylamine, 1-aminoanthracene, 2-aminoanthracene, 9-aminoanthracene, β-aminostyrene, 1,3,5-hexatrien-1-amine, N,N-dimethyl-1,3,5-hexatrien-1-amine, 3-amino-2-propenal, 4-amino-3-buten-2-one, trimethylamine, triethylamine, tripropylamine, tributylamine, tripentylamine, trihexylamine, triheptalamine, trioctylamine and trinonylamine, butylamine, pentylamine, hexylamine, octylamine, dipropylamine, dibutylamine, dihexylamine, trimethylamine, triheptylamine, and/or mixtures thereof.

11. The silicone rubber foam composition in accordance with claim 1, comprising one or more additional additives selected from foam stabilizers, adhesion promoters; colorants, dyes and pigments; antioxidants; heat stabilizers; flame retardants; flow control additives and/or reinforcing and/or non-reinforcing fillers.

12. A silicone rubber foam which is a foamed and cured product of the composition in accordance with claim 1.

13. The silicone rubber foam in accordance with claim 12 having a density of less than 0.8 g/cm³.

14. A method of making a silicone rubber foam composition, the method comprising:
mixing a silicone rubber foam composition comprising
(a) one or more organosilicon compounds having an average of at least two silicon bonded alkoxy groups per molecule selected from one or more silicone resins and/or silicone resin intermediates;
(b) a Lewis acid catalyst;
(c) one or more surfactants; and
(d) one or more organopolysiloxane polymers having an average of at least two, optionally at least three silicon bonded hydrogen groups per molecule; and
causing foaming while the composition cures.

15. (canceled)
